(19) United States
(12) Patent Application Publication
(10) Pub. No.: US 2023/0083868 A1
(43) Pub. Date: Mar. 16, 2023

(54) IMPLICIT WAITING CONTROLS FOR A COMMUNICATION SYSTEM

(71) Applicant: Intercom, Inc., San Francisco, CA (US)

(72) Inventors: Eoin Nolan, Dublin (IE); Alex Potrivaev, Dublin (IE)

(21) Appl. No.: 17/668,169

(22) Filed: Feb. 9, 2022

Related U.S. Application Data
(60) Provisional application No. 63/243,003, filed on Sep. 10, 2021.

(51) Int. Cl. H04L 67/50; H04L 51/56; H04L 51/02

(52) U.S. Cl. CPC H04L 67/535; H04L 51/56; H04L 51/02

(57) ABSTRACT

A system and method for optimizing a channel for delivering a communication to a user device. The method includes determining, by a processing device, engagement of a user with a product. The method includes selecting, by the processing device, a communication channel to send a communication to a user device associated with the user based on the engagement of the user with the product. The method includes sending, by the processing device, the communication via an in-product channel to the user device when the user is engaged with the product or via an out-of-product channel to the user device when the user has not engaged with the product within a predetermined amount of time.

### CROSS-REFERENCE TO RELATED APPLICATION

This application claims priority to, and benefit of, U.S. Provisional Patent Application No. 63/243,003, filed Sep. 10, 2021, the entire contents of which are hereby incorporated by reference.

### TECHNICAL FIELD

The present disclosure relates to systems and methods for managing communications and, more specifically, systems and methods for managing communications with users and potential users of a system.

### BACKGROUND

Customer relationship management (CRM) software is software that automates and manages interactions with an organization. A conversational messaging system may allow an organization to define conversational experiences for commerce, marketing, and support using in-product channels (chatbots, live messaging, banners) and out-of-product channels (email and SMS messages). CRM software or conversational messaging systems may be used by an organization to maintain contact with customers and quickly respond to their needs. CRM software or conversational messaging systems may be used by an organization to increase engagement with the organization.

### SUMMARY

One aspect disclosed herein is directed to a method that includes determining, by a processing device, engagement of a user with a product. In some embodiments, the method includes selecting, by the processing device, a communication channel to send a communication to a user device associated with the user based on the engagement of the user with the product. In some embodiments, the method includes sending, by the processing device, the communication via an in-product channel to the user device when the user is engaged with the product or via an out-of-product channel to the user device when the user has not engaged with the product within a predetermined amount of time.

In another aspect, the present disclosure is directed to a system that includes a memory and a processing device that is operatively coupled to the memory. In some embodiments, the processing device determines engagement of a user with a product. In some embodiments, the processing device selects a communication channel to send a communication to the user device based on the engagement of the user with the product. In some embodiments, the processing device sends communication via an in-product channel to the user device when the user is engaged with the product or via an out-of-product channel to the user device when the user has not reengaged with the product within a predetermined amount of time.

In another aspect, the present disclosure is directed to a non-transitory computer-readable medium storing instructions that, when executed by a processing device, cause the processing device to determine engagement of a user with a product. In some embodiments, the instructions may cause the processing device to select a communication channel to send a communication to a user device associated with the user based on the engagement of the user with the product. In some embodiments, the instructions may cause the processing device to send the communication via an in-product channel to the user device when the user is reengaged with the product or via an out-of-product channel to the user device when the user has not engaged with the product within a predetermined amount of time.

It will therefore be appreciated that this Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects, and advantages will become apparent from the following detailed description taken in conjunction with the accompanying figures which illustrate, by way of example, the principles of some described example implementations.

Further, to the extent consistent, any of the embodiments or aspects described herein may be used in conjunction with any or all of the other embodiments or aspects described herein.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1A is a block diagram depicting an example environment for managing communications with users and potential users of a communication system, according to some embodiments;

FIG. 1B is a block diagram depicting an example of the communication system of FIG. 1A, according to some embodiments;

FIG. 1C is a block diagram depicting an example of the end user device of FIG. 1A, according to some embodiments;

FIG. 2 is a block diagram of an example control, according to some embodiments;

FIG. 3 is a flow chart of a method of executing the control of FIG. 2, according to some embodiments; and

FIG. 4 is a block diagram of an example computing device 400 that may perform one or more of the operations described herein, according to some embodiments.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements.

As used herein, the term “communication system” may refer to the system and/or program that manages communications between individuals and companies. The term “customer” may refer to a company or organization utilizing the communication system to manage relationships with its end users or potential end users (leads). The term “user” may refer to an end user or lead that is interfacing with the customer through the communication system. The term “company” may refer to an organization or business that includes a group of users. The term “engineer” may refer to staff managing or programing the communication system. The term “product” may refer to a website, application, or program of the customer.

As described in the below passages, the communication system may place (e.g., assign, allocate) user objects associated with a user device of a user into user paths developed by a customer, monitor interaction of users with customer products, and communicate with the users via the user device based on interactions with the customer products to advance user objects through the user paths. The communication system may monitor and/or detect interactions of the user with the customer's product and advance the user objects along the user paths based on conditions set by the customer during development of the user paths. The interactions of the users may include, but not be limited to, accessing a product, moving through pages within the product, utilizing features of the product, making a purchase within the product. The communication system, the customer, and/or third party software may communicate with the users via the user devices as the user objects are advanced through the user paths. Communications with the users may include, but not be limited to, banners, pop-ups, chat windows, in product direct messaging, emails, push messages, instant messages, or short message service (SMS) messages. The communication system may include reporting functions that allow a customer to monitor the status of user objects along the developed user paths.

When a user object is in a user path, a user device associated with the user may receive communication or content through in-product channels and/or out-of-product channels. An in-product channel may be a channel that provides a message to a user device when the user device is actively using a product, e.g., a website, application, or program. An in-product channel may be a one-way communication channel or may be a two-way communication channel. In some embodiments, an in-product channel may be a banner that displays on a webpage or within an application, e.g., a banner ad. Other in-product channels include, but are not limited to, pop-ups, chat windows, or other in product messaging.

An out-of-product channel may be a channel that communicates with a user device associated with a user when the user device is not actively using a product. Out-of-product channels may include, but are not limited to, emails, push messages, or SMS messages. Out-of-product channels may be a one-way communication channel or may be a two-way communication channel. Out-of-product channels may be used to bring a user back to a product. In some embodiments, an email reminder may be sent to a user device if an associated user has not engaged with a product for 10 days in an effort to get the user to comeback or reengage with the product.

It is understood that communicating with a user actively engaged with a product is more effective than communicating with a user that is not actively engaged with a product. As such, it is understood that in-product channels are more effective than out-of-product channels for communicating with a user. However, when a user becomes disengaged with a product, e.g., has not used a product for a period of time, it may be necessary to use an out-of-product channel to get a user to reengage with the product. In some embodiments, a user may begin highly engaged with a product and then become disengaged with the product over time. When the user is highly engaged, in-product channels may be effective to maintain engagement of the user with the product or to increase engagement of the user with the product. Once the user is no longer engaged with the product, in-product channels will not reach the user such that out-of-product channels may be the only channels that will reach the user.

Existing communication systems do not differentiate between in-product channels and out-of-product channels. As a result, existing communication systems may send an in-product message to a user device when the user device is no longer engaged with the product. These in-product messages may not reach the user device or may be received by the user device after the message is no longer relevant. Sending an in-product message to a user device that does not reach a user device or not timely received may cause a user to become confused or decrease a user's engagement with a product. In some embodiments, a customer may believe an in-product message was received by a user device even though the user device was not engaged with the product and did not receive the message. This misbelief of a customer may decrease a customer's perception of the communication system and/or may cause a customer to leave the communication system.

When an existing communication system provides an out-of-product message to a user device when the user is actively engaged with the product, the user may receive the message after it is no longer relevant. As an example, the user device may receive an email requesting the user sign up for a product after the user already signed up. Such a message may reduce a user's perception of the product for sending an irrelevant or expired message. In another example, the out-of-product message may be a discount code for a purchase that the user already made. The discount code may cause the user to return and repurchase the product or to contact customer service to take advantage of the discount. As such, an out-of-product message may increase the cost of a sale instead of decreasing the cost of the sale as intended by the use of the communication system.

As described in greater detail below, a control for a communication system is disclosed that is capable of providing and differentiating between in-product channel messages and out-of-product channel messages. The disclosed communication system may optimize a channel for sending a message to a user device based on the user's engagement with a product of the customer. Optimizing a channel for sending a message to a user may increase user engagement with a product, increase a user's perception of a customer or a customer's product; increase sales for a customer, increase a number of users of a product, and/or increase a customer's perception of the communication system.

Optimizing a channel for sending a message may provide a customer with additional options for communicating with a user by not forcing the customer to choose to send a message via one channel over another or to send both an in-product channel message and an out-of-product channel message to make sure the user receives an important communication. The communication system may delay an in-product message from being sent until a user is engaged with a product and/or may send an out-of-product message to a user to reengage with the product before sending the in-product message. Delaying an in-product message or sending an out-of-product message to a user may increase user engagement with a product, increase sales from a product, may increase a number of users of a product, and/or may increase a customer's perception of the communication system.

Optimizing a channel for sending a communication may improve performance of the communication system. In some embodiments, optimizing a channel for sending a communication may decrease resources required to operate the communication system. In certain embodiments, optimizing a channel for sending a message to a user may decrease network bandwidth required to send communications to the user. Decreasing network bandwidth required to send the communications to users may reduce network congestion.

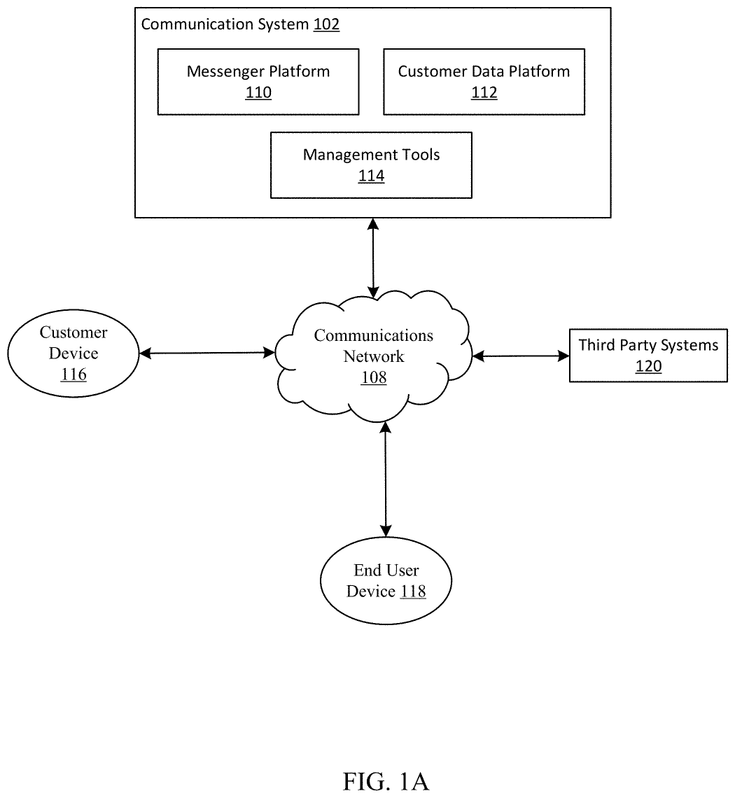

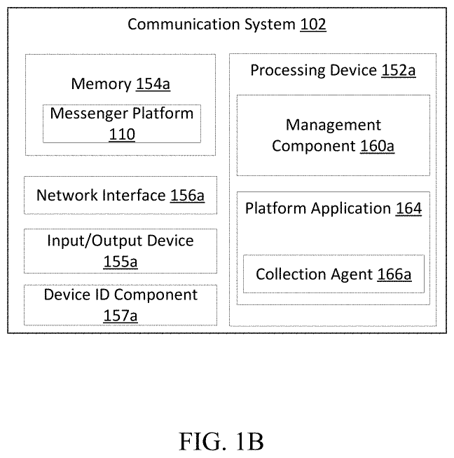

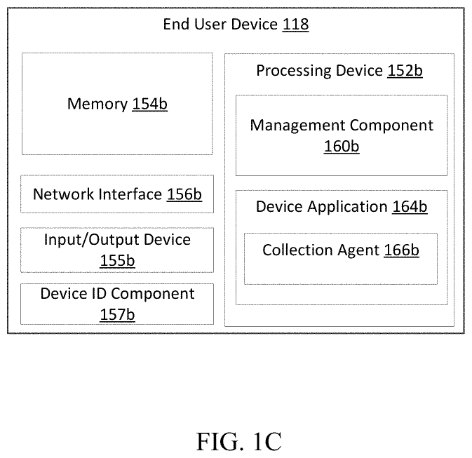

FIG. 1A is a block diagram depicting an example environment for managing communications with users and potential users of a communication system, according to some embodiments. As shown, the environment 100 includes a communication system 102 that is interconnected with a customer device 116, an end user device 118, and third party systems 120 via a communications network 108. The communications network 108 may be the internet, a wide area network (WAN), intranet, or other suitable network. The communication system 102 may be hosted on one or more local servers, may be a cloud based system, or may be a hybrid system with local servers and in the cloud. The communication system 102 is maintained by engineers which develop management tools 114 that include an interface or editor for clients of the communication system 102 to interface with the communication system 102.

The communication system 102 includes management tools 114 that are developed to allow customers to develop user series or user paths in the form of nodes and edges (e.g., connections) that are stored in a customer data platform 112 of the communication system 102. The communication system 102 includes a messenger platform 110 that interacts with end user devices 118 in accordance with the user paths stored in the customer data platform 112.

A customer interacts with the communication system 102 by accessing a customer device 116. The customer device 116 may be a general purpose computer or a mobile device. The customer device 116 allows a customer to access the management tools 114 to develop the user paths stored in the customer data platform 112. For example, the customer device 116 may execute an application using its hardware (e.g., a processor, a memory) to send a request to the communication system 102 for access to a graphical editor, which is an application programming interface (API) stored in the management tools 114. In response to receiving the request, the communication system 102 may send a software package (e.g., executable code, interpreted code, programming instructions, libraries, hooks, data, etc.) to the customer device 116 to cause the customer device 116 to execute the software package using its hardware (e.g., processor, memory). In some embodiments, the application may be a desktop or mobile application, or a web application (e.g., browser). The customer device 116 may utilize the graphical editor to build the user paths within the graphical editor. The graphical editor may periodically send copies (e.g., snapshots) of the user path as it is being built to the communication system 102, which in turn, may store the user paths to the customer data platform 112. The user paths manage communication of the customer with a user to advance a user object associated with the user through the user paths. The user paths may be developed to increase engagement of a user with the customer via the messenger platform 110.

The messenger platform 110 may interact with a user through an end user device 118 that accesses the communication network 108. The end user device 118 may be a general purpose computer or mobile device that accesses the communication network 108 via the internet or a mobile network. The user may interact with the customer via a website of the customer, a messaging service, or interactive chat. In some embodiments, the user paths may allow a customer to interface with users through mobile networks via messaging or direct phone calls. In some embodiments, a customer may develop a user path in which the communication system 102 interfaces with a user device via a non-conversational channel such as email.

The communication system 102 includes programs or workers that place user objects into the user paths developed by the customers stored in the customer data platform 112. The communication system 102 may monitor progress of the user objects through the user paths developed by the customer and interact with the customer based on the nodes and edges developed by the customer for each user path. In some embodiments, the communication system 102 may remove user objects from user paths based on conditions developed by the customer or by the communication system 102.

The communication system 102 and/or the customers may employ third party systems 120 to receive (e.g., retrieve, obtain, acquire), update, or manipulate (e.g., modify, adjust) the customer data platform 112 or user data which is stored in the customer data platform 112. For example, a customer may utilize a third party system 120 to have a client chat directly with a user via the end user device 118 or may utilize a bot (e.g., a software program that performs automated, repetitive, and/or pre-defined tasks) to interact with a user via the end user device 118 via chat or messaging.

Although FIG. 1A shows only a select number of computing devices and/or systems (e.g., communication system 102, customer device 116, third party systems 120, and end user device 118), the environment 100 may include any number of computing devices and/or systems that are interconnected in any arrangement to facilitate the exchange of data between the computing devices and/or systems.

FIG. 1B is a block diagram depicting an example of a communication system 102 of FIG. 1A, according to some embodiments. While various devices, interfaces, and logic with particular functionality are shown, it should be understood that the communication system 102 includes any number of devices and/or components, interfaces, and logic for facilitating the functions described herein. For example, the activities of multiple devices may be combined as a single device and implemented on a same processing device (e.g., processing device 152a), as additional devices and/or components with additional functionality are included.

The communication system 102 includes a processing device 152a, a memory 154a, an input/output device 155a, a network interface 156a, and a device ID component 157a. The memory 154a may include the messenger platform 110 stored therein. The processing device 152a may include a management component 160a or a platform application 164a. The platform application 164a may include a collection agent 166a.

The processing device 152a of the messenger platform 110 may determine engagement of a user with a product, select a communication channel to send a communication to an end user device associated with the user based on engagement of the user with the product, or send the communication via an in-product channel or an out-of-product channel. The processing device 152a may advance a user object through a user path executed by the processing device 152a.

The processing device 152a includes (e.g., general purpose processor, a PLD, etc.), which may be composed of one or more processors, and a memory 154a (e.g., synchronous dynamic random access memory (DRAM), read-only memory (ROM)), which may communicate with each other via a bus (not shown).

The processing device 152a may be provided by one or more general-purpose processing devices such as a microprocessor, central processing unit, or the like. In some embodiments, processing device 152a may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 152a may comprise one or more special-purpose processing devices such as an application specific integrated circuit (ASIC), a field programmable gate array (FPGA), a digital signal processor (DSP), network processor, or the like. The processing device 152a may be configured to execute the operations described herein, in accordance with one or more aspects of the present disclosure, for performing the operations and steps discussed herein.

The processing device 152a may include and/or execute an application (shown in FIG. 1B as, “platform application 164a”) that is displayed on a computer screen of the communication system 102. In some embodiments, the platform application 164a may be an application that is or has undergone one or more stages of a software development process for the purpose of developing the application into a final product for private use, public use, and/or commercial use. In some embodiments, the platform application 164a may be configured to need one or more computing resources (e.g., networking resources, data storage resources, processing resources, one or more files) in order to completely execute (e.g., execute without error and/or interruption). In some embodiments, the platform application 164a may be configured to send a communication, via the communications network 108 (shown in FIG. 1A) to the customer device 116 or the end user device 118.

The platform application 164a may include a collection agent 166a. The collection agent 166a may include an application plug-in, application extension, subroutine, browser toolbar, daemon, or other executable logic for collecting data processed by the platform application 164a and/or monitoring interactions of the end user device 118. In other embodiments, the collection agent 166a may be a separate application, service, daemon, routine, or other executable logic separate from the platform application 164a but configured for intercepting and/or collecting data processed by platform application 164a, such as a screen scraper, packet interceptor, application programming interface (API) hooking process, or other such application. The collection agent 166a may capture interactions with a product, e.g., a website, an application, or a program, by the end user device 118. In some embodiments, the collection agent 166a generates collection data based on communications received from end user device 118 via the network interface 156a by way of the communications network 108.

The processing device 152a may execute a management component 160a. In some embodiments, the management component 160a may be configured to launch and/or execute a user path. In some embodiments, the management component 160a may be configured to launch (e.g., start, trigger, activate) the platform application 164a to cause platform application 164a to execute on the processing device 152a. The management component 160a may identify and move user objects representative of a user interfacing with the messenger platform 110 via an end user device 118 through the user paths. At times, the user paths and/or the user objects may store in the memory 154a.

The memory 154a (e.g., Random Access Memory (RAM), Read-Only Memory (ROM), Non-volatile RAM (NVRAM), Flash Memory, hard disk storage, optical media, etc.) stores data and/or computer instructions/code for facilitating at least some of the various processes described herein. The memory 154a includes tangible, non-transient volatile memory, or non-volatile memory. The memory 154a stores programming logic (e.g., instructions/code) that, when executed by the processing device 152a, controls the operations of the messenger platform 110. In some embodiments, the processing device 152a and the memory 154a form various processing devices and/or circuits described with respect to the messenger platform 110. The instructions include code from any suitable computer programming language such as, but not limited to, C, C++, C#, Java, JavaScript, VBScript, Perl, HTML, XML, Python, TCL, and Basic.

The communication system 102 includes a network interface 156a configured to establish a communication session with a computing device for sending and receiving data over the communication network 108 to the computing device. Accordingly, the network interface 156a includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some embodiments, the messenger platform 110 includes a plurality of network interfaces 156a of different types, allowing for connections to a variety of networks, such as local area networks (public or private) or wide area networks including the Internet, via different sub-networks.

The communication system 102 may include an input/output device 155a configured to receive input from and provide information to engineers. In this regard, the input/output device 155a is structured to exchange data, communications, instructions, etc. with an input/output component of the communication system 102. Accordingly, input/output device 155a may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interfaces may be internal to the housing of the communication system 102, such as a built-in display, touch screen, microphone, etc., or external to the housing of the communication system 102, such as a monitor connected to the communication system 102, a speaker connected to the communication system 102, etc., according to various embodiments. In some embodiments, the communication system 102 includes communication circuitry for facilitating the exchange of data, values, messages, and the like between the input/output device 155a and the components of the communication system 102. In some embodiments, the input/output device 155a includes machine-readable media for facilitating the exchange of information between the input/output device 155a and the components of the communication system 102. In still another embodiment, the input/output device 155a includes any combination of hardware components (e.g., a touchscreen), communication circuitry, and machine-readable media.

The communication system 102 includes a device identification component 157a (shown in FIG. 1B as device ID component 157a) configured to generate and/or manage a device identifier associated with the communication system 102. The device identifier may include any type and form of identification used to distinguish the communication system 102 from other computing devices. In some embodiments, to preserve privacy, the device identifier may be cryptographically generated, encrypted, or otherwise obfuscated by any device and/or component of communication system 102. In some embodiments, the communication system 102 may include the device identifier in any communication (e.g., establish connection request, resource request) that the communication system 102 sends to a computing device.

The communication system 102 includes a bus (not shown), such as an address/data bus or other communication mechanism for communicating information, which interconnects the devices and/or components of communication system 102, such as processing device 152a, memory 154a, network interface 156a, input/output device 155a, device ID component 157a, and management component 160a.

In some embodiments, some or all of the devices and/or components of the messenger platform 110 may be implemented with the processing device 152a. For example, the messenger platform 110 may be implemented as a software application stored within the memory 154a and executed by the processing device 152a. Accordingly, such embodiments can be implemented with minimal or no additional hardware costs. In some embodiments, any of these above-recited devices and/or components rely on dedicated hardware specifically configured for performing operations of the devices and/or components.

FIG. 1C is a block diagram depicting an example of an end user device of FIG. 1A (e.g., end user device 118) of the environment in FIG. 1, according to some embodiments. While various devices, interfaces, and logic with particular functionality are shown, it should be understood that the end user device 118 includes any number of devices and/or components, interfaces, and logic for facilitating the functions described herein. For example, the activities of multiple devices may be combined as a single device and implemented on a same processing device (e.g., processing device 152b), as additional devices and/or components with additional functionality are included.

The end user device 118 includes a processing device 152b, a memory 154b, an input/output device 155b, a network interface 156b, and a device ID component 157b. The processing device 152b may include a management component 160b or a device application 164b. The device application 164b may include a collection agent 166b.

The end user device 118 includes the processing device 152b (e.g., general purpose processor, a PLD, etc.), which may be composed of one or more processors. The processing device 152b includes identical or nearly identical functionality as processing device 152a in FIG. 1B, but with respect to devices and/or components of the end user device 118 instead of devices and/or components of the communication system 102.

The processing device 152b may execute a device application 164b that is communicably coupled to the communication network 120 allowing the end user device 118 to send/receive data (e.g., requests, end user data, application data, user inputted data, etc.) to any other computing devices connected to the communication network 120. The device application 164b is configured to display information (e.g., application data) that the end user device 118 receives from any other computing device (e.g., communication system 102). The device application 164b may be an internet/web browser, a graphic user interface (GUI), an email reader/client, a file transfer protocol (FTP) client, a virtual machine application, or a software application that is spate from an internet/web browser. The device application 164 may be or interact with a product monitored by the collection agent 166a of the communication system 102.

The device application 164b includes a collection agent 166b. The collection agent 166b may include an application plug-in, application extension, subroutine, browser toolbar, daemon, or other executable logic for collecting data processed by the device application 164b and/or monitoring interactions of user with the input/output device 155b. In other embodiments, the collection agent 166b may be a separate application, service, daemon, routine, or other executable logic separate from the device application 164b but configured for intercepting and/or collecting data processed by device application 164b, such as a screen scraper, packet interceptor, application programming interface (API) hooking process, or other such application. The collection agent 166a is configured for intercepting or receiving data input via the input/output device 157b, including mouse clicks, scroll wheel movements, gestures such as swipes, pinches, or touches, or any other such interactions; as well as data received and processed by the device application 164b. The collection agent 166b is configured to pass any data that it intercepts, gathers, and/or receives data to the device application 164b to be presented in the device application 164b (e.g., on a display/monitor) and/or for the application to sends the data to the messenger platform 110. In some embodiments, the collection agent 116b may be embedded in code received by and executed by the device application 164b. When executed, the collection agent 116b may gather and generate engagement information or data from the end user device 118 representative of activity of a user with the end user device 118 and/or engagement of the user with a product. The collection agent 116b may transmit the engagement data with the collection agent 166a of the communication system 102 via the network interface 156a by way of the communication network 108. The collection agent 116b, may begin intercepting, gathering, and/or receiving data input via its respective input/output circuit in view of any triggering event, including, e.g., a power-up of the end user device 118 or a launch of any software application executing on a processing device of end user device 118. In some embodiments, the collection agent 166b may begin intercepting, gathering, and/or receiving data responsive to a user scanning a quick response (QR) code associated with a product identifier or a barcode associated with a product identifier.

The memory 154b stores data and/or computer instructions/code for facilitating at least some of the various processes described herein. The memory 154b includes identical or nearly identical functionality as the memory 154a in FIG. 1B, but with respect to devices and/or components of the end user device 118 instead of devices and/or components of the communication system 102.

The end user device 118 includes a network interface 156b configured to establish a communication session with a computing device for sending and receiving data over a network to the computing device. Accordingly, the network interface 156a includes identical or nearly identical functionality as the network interface 156a in FIG. 1B, but with respect to devices and/or components of the end user device 118 instead of devices and/or components of the communication system 102.

The input/output device 155b may be similar to the input/output device 155a in FIG. 1B, but with respect to devices and/or components of the end user device 118 instead of devices and/or components of the communication system 102.

The device identification component 157b may be similar to the device identification component 157a in FIG. 1B, but with respect to devices and/or components of the end user device 118 instead of devices and/or components of the communication system 102.

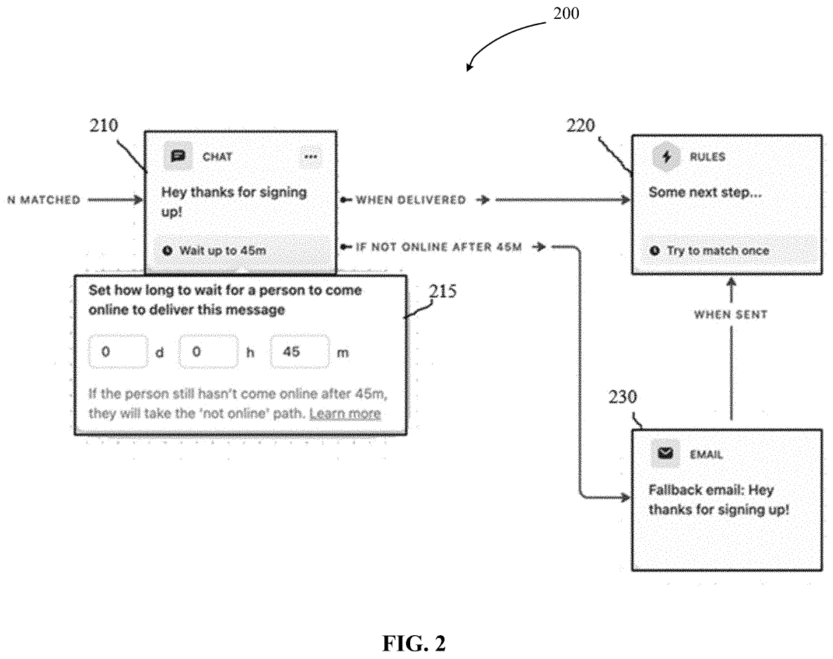

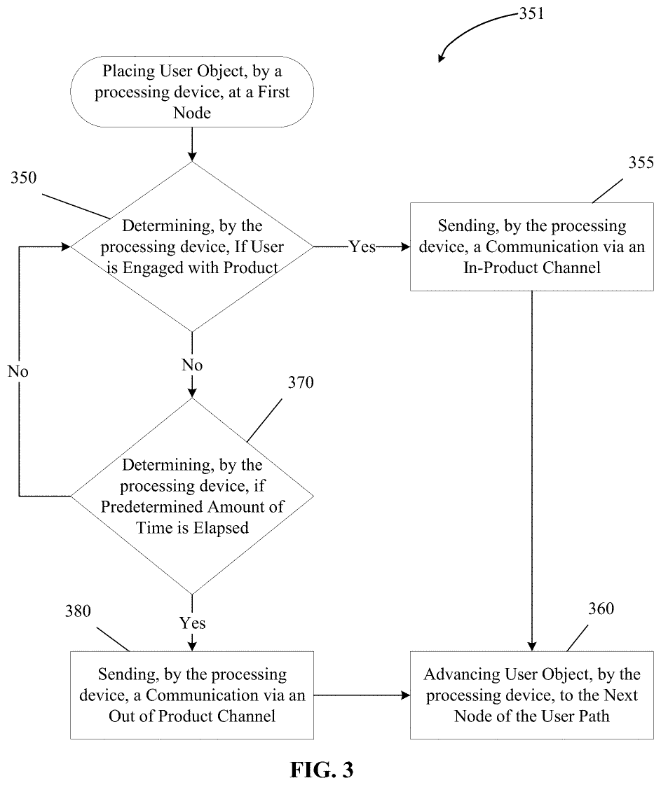

Referring to FIGS. 2 and 3, an implicit waiting control and a method of executing the implicit waiting control is provided in accordance with the present disclosure and is referred to as control 200 and method 351, respectively. The method 351 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, one or more of the operations of method 351 may be performed by the communication system 102, the customer device 116, the end user device 118, and/or the third party system 120 of FIG. 1A. In some embodiments, the method 351 may be executed on the processing device 152a of the communication system 102 of FIG. 1B.

When a user object associated with a user is in a user path, the customer may have a message or communication to send to the user via an end user device 118. The message may be important or timely such that the customer wants to optimize the delivery channel of the message to the user via the most effective channel. The message may be sent to the user via an in-product channel or via an out-of-product channel. The customer may use the control 200 to optimize the channel for providing the message to the user. In embodiments, when the user is engaged with the product, the communication system 102 will send the message via an in-product channel and when the user is disengaged with the product, the communication system 102 will send the message via an out-of-product channel. The control 200 may prevent duplicate messages from being sent to the user via separate channels. The communication system 102 may send the message to the user via an in-product channel or an out-of-product channel based on the engagement of the user with the product.

When the user object reaches the node 210 by being advanced or entering a user path, the communication system 102 may attempt to communicate with the user through the end user device 118 via an in-product channel. Before sending the message via an in-product channel, a processing device 152a of the communication system 102 may determine engagement of the end user device 118 with the product of the customer (Operation 350). When the end user device 118 is engaged with the product, the messaging platform 110 sends the message via an in-product channel (Operation 355). In some embodiments, the processing device 152a of the communication system 102 may send an in-product chat to the end user device 118 to deliver the message. After the message is delivered, a processing device 152a of the communication system 102 may advance the user object to the next node 220 of the user path (Operation 360). In some embodiments, the processing device 152a of the communication system 102 may confirm the end user device 118 received the message before advancing the user object to the next node.

When the processing device 152a of the communication system 102 determines the end user device 118 is not engaged with the product of the customer, the processing device 152a of the communication system 102 may wait a predetermined amount of time for the end user device 118 to reengage the product of the customer such that the message may be delivered to the end user device 118 via an in-product channel (Operation 370). The processing device 152a of the communication system 102 may periodically check for user engagement with the product while waiting for the predetermined amount of time such that the message may be sent when the end user device 118 is engaged with the product (Operation 350). The predetermined amount of time 215 may be selected by a customer when the user path is developed. The predetermined amount of time may be any amount of time selected by the customer. The predetermined amount of time may be selected based on an urgency of a message, a regulatory requirement, a duration of a promotion, and/or historical data. The predetermined amount of time may be in range of 1 minute to 31 days. In some embodiments, the predetermined amount of time may be greater than 31 days.

If the predetermined amount of time elapses without the end user device 118 engaging the product, e.g., without the user object advancing from node 210, the processing device 152a of the communication system 102 sends the message to the end user device 118 via an out-of-product channel (Operation 380). As shown, if the end user device 118 does not engage with the product for the predetermined amount of time, e.g., 45 minutes, the processing device 152a of the communication system 102 sends the message to the user as an email or an SMS message. Once the message is sent to the end user device 118 via the out-of-product channel, the processing device 152a of the communication system 102 may advance the user object to the next node 220 (Operation 360). Advancement of the user object to the next node may be to the same node as if the communication system 102 sent the message via an in-product channel or advancement of the user object to the next node may be to a different node based on the end user device 118 being sent an in-product channel message or an out-of-product channel message.

The implicit waiting control 200 refers to a control that determines to send a message via an in-product channel when a user is engaged with a product, will periodically reattempt to send the message via an in-product channel when the user is engaged with the product for a predetermined amount of time, and send the message to the end user device 118 via an out-of-product channel if the user does not reengage the product within the predetermined amount of time. A customer may use the implicit waiting control 200 to optimize the channel to send a message to the user. As noted above, optimizing the channel to send a message to a user may increase user engagement with a product, increase a user's perception of a customer or a customer's product, increase sales for a customer, increase a number of users of a product, and/or increase a customer's perception of the communication system. Optimizing a channel for sending a message may provide a customer with additional options for communicating with a user by not forcing the customer to choose to send a message via one channel over another or to send both an in-product channel message and an out-of-product channel message to make sure the user receives an important communication regardless of engagement with a product.

In the example shown, once a user signs up for a particular product, the user enters the user path 200 and is placed at node 210. If the user engages the product within 45 minutes of signing up, a processor of the messaging system 110 communicates with the user via an in-product chat to thank the user for signing up (Operation 350). If the user does not engage the product within 45 minutes, the processor of the messaging system 110 sends an email to the user to thank the user for signing up (Operation 265). Once the in-product chat or the out-of-product chat is sent, the processor of the messaging system 110 advances the user to the next node 220.

The implicit waiting control 200 may allow communication via an in-product channel or an out-of-product channel without duplicating or providing redundant communication. The implicit waiting control 200 may allow for optimization of the communication channel with the user. Not providing redundant communication may enhance a user's perception of the product. The implicit waiting control 200 may allow a customer to send a single copy of a message without having to send a copy of the message over multiple channels to contact the user.

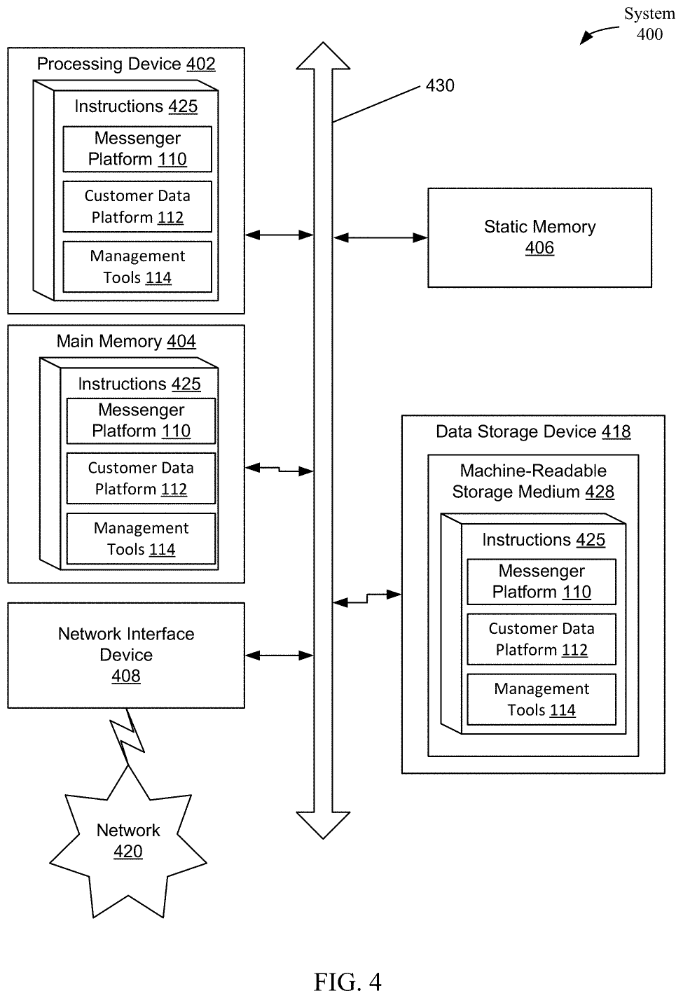

FIG. 4 is a block diagram of an example computing device 400 that may perform one or more of the operations described herein, in accordance with some embodiments. Computing device 400 may be connected to other computing devices in a LAN, an intranet, an extranet, and/or the Internet. The computing device may operate in the capacity of a server machine in a client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. In some embodiments, while only a single computing device is illustrated, the term “computing device” may be taken to include any collection of computing devices that individually or jointly execute a set (or multiple sets) of instructions to perform the methods discussed herein.

The example computing device 400 may include a processing device (e.g., a general purpose processor, a PLD, etc.) 402, a main memory 404 (e.g., synchronous dynamic random access memory (DRAM), read-only memory (ROM)), a static memory 406 (e.g., flash memory and a data storage device 418), which may communicate with each other via a bus 430.

Processing device 402 may be provided by one or more general-purpose processing devices such as a microprocessor, central processing unit, or the like. In an illustrative example, processing device 402 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 402 may comprise one or more special-purpose processing devices such as an application specific integrated circuit (ASIC), a field programmable gate array (FPGA), a digital signal processor (DSP), network processor, or the like. The processing device 402 may be configured to execute the operations described herein, in accordance with one or more aspects of the present disclosure, for performing the operations and steps discussed herein.

Computing device 400 may include a network interface device 408 which may communicate with a communication network 420. The computing device 400 may include a video display unit (e.g., a liquid crystal display (LCD) or a cathode ray tube (CRT)), an alphanumeric input device (e.g., a keyboard), a cursor control device (e.g., a mouse) and an acoustic signal generation device (e.g., a speaker). In one embodiment, video display unit, alphanumeric input device, and cursor control device may be combined into a single component or device (e.g., an LCD touch screen).

Data storage device 418 may include a computer-readable storage medium 428 on which may be stored one or more sets of instructions 425 that may include instructions for one or more components (e.g., messenger platform 110, the customer data platform 112, and the management tools 114) for carrying out the operations described herein, in accordance with one or more aspects of the present disclosure. Instructions 425 may reside, completely or at least partially, within main memory 404 and/or within processing device 402 during execution thereof by computing device 400, main memory 404 and processing device 402 constituting computer-readable media. The instructions 425 may be transmitted or received over a communication network 420 via network interface device 408.

While computer-readable storage medium 428 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” may be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Examples described herein may relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. The terms “comprises”, “comprising”, “includes”, and/or “including”, when used herein, may specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

In some embodiments, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in a manner that is capable of performing the task(s) at issue. “Configured to” may include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or an unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present embodiments to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present embodiments are not to be limited to the details given herein, but may be modified within the scope and equivalents of the appended claims.

1. A method comprising:
determining, by a processing device, engagement of a user with a product;
selecting, by the processing device, a communication channel to send a communication to a user device associated with the user based on the engagement of the user with the product; and
sending, by the processing device, the communication via an in-product channel to the user device when the user is actively engaged with the product or via an out-of-product channel to the user device when the user device has not actively engaged with the product within a predetermined amount of time, the communication being a message which is the same whether sent via the in-product channel or the out-of-product channel.

2. The method of claim 1, further comprising advancing, by the processing device, a user object associated with the user device to a subsequent node responsive to the communication being sent via the in-product channel or the out-of-product channel.

3. The method of claim 1, further comprising identifying, by the processing device, a user object associated with the user device reaching an initial node before determining engagement of the user device with the product.

4. The method of claim 1, wherein sending the communication via the in-product channel comprises displaying a banner ad, displaying a pop-up, opening a chat window, or sending a message within a chat window.

5. The method of claim 1, wherein sending the communication via the out-of-product channel comprises sending an email, sending a push message, or sending a short message service (SMS) message.

6. The method of claim 1, further comprising receiving, by the processing device, the predetermined amount of time from a customer device.

7. The method of claim 1, wherein determining the predetermined amount of time includes the predetermined amount of time being in a range of 1 minute to 31 days.

8. The method of claim 1, wherein sending the communication via the out-of-product channel comprises verifying, by the processing device, that the communication has not been sent via an in-product channel before sending the communication via the out-of-product channel.

9. The method of claim 1, further comprising preventing, by the processing device, the communication from being sent via both the in-product channel and the out-of-product channel.

10. The method of claim 1, wherein determining engagement of the user with the product comprises determining an application executing on the user device, determining the user viewing a website on the user device, or determining a program executing on the user device.

11. A system comprising:
a memory; and
a processing device, operatively coupled to the memory, to:
determine engagement of a user with a product;
select a communication channel to send a communication to a user device associated with the user based on the engagement of the user with the product; and
send the communication via an in-product channel to the user device when the user is actively engaged with the product or via an out-of-product channel to the user device when the user has not actively engaged with the product within a predetermined amount of time, the communication being a message which is the same whether sent via the in-product channel or the out-of-product channel.

12. The system of claim 11, wherein the processing device is further to advance a user object associated with the user device to a subsequent node responsive to the communication being sent.

13. The system of claim 11, wherein the processing device is further to identify a user object associated with the user device reaching an initial node before determining engagement of the user with the product.

14. The system of claim 11, wherein the processing device to send the communication via the in-product channel includes displaying a banner ad, displaying a pop-up, opening a chat window, or sending a message within a chat window.

15. The system of claim 11, wherein the processing device to send the communication via the out-of-product channel includes sending an email, sending a push message, or sending a short message service (SMS) message.

16. The system of claim 11, wherein the processing device is further to receive the predetermined amount of time from a customer device.

17. The system of claim 11, wherein the processing device to send the communication via the out-of-product channel includes to verify that the communication was not sent before sending the communication via the out-of-product channel.

18. The system of claim 11, wherein the processing device is further to prevent the communication from being sent via both an in-product channel and an out-of-product channel.

19. The system of claim 11, wherein the processing device to determine engagement of the user with the product comprises determining an application executing on the user device, determining the user device displaying a webpage on a display, or determining a program executing on the user device.

20. A non-transitory computer-readable medium storing instructions that, when executed by a processing device, cause the processing device to:
determine engagement of a user with a product;
select a communication channel to send a communication to a user device associated with the user based on the engagement of the user with the product; and
send the communication via an in-product channel to the user device when the user is actively engaged with the product or via an out-of-product channel to the user device when the user has not actively engaged with the product within a predetermined amount of time, the communication being a message which is the same whether sent via the in-product channel or the out-of-product channel.
